(19) United States
(12) Patent Application Publication
(10) Pub. No.: US 2004/0119188 A1
(43) Pub. Date: Jun. 24, 2004

(54) Impregnated fiber precursors and methods and systems for producing impregnated fibers and fabricating composite structures

(76) Inventor: Kenneth A. Lowe, Clearfield, UT (US)

Correspondence Address: TRASK BRITT, P.O. BOX 2550, SALT LAKE CITY, UT, 84110, US

(21) Appl. No.: 10/327,688

(22) Filed: Dec. 20, 2002

(51) Int. Cl. B28B 11/06

(52) U.S. Cl. 264/131

(57) ABSTRACT

Methods, apparatus, and systems for impregnation of fibers and their use in the fabrication of composite structures using two or more different but cooperative matrix components applied to separate tows of dry fibers to form single component prepregs. A single tow of dry fibers may also be impregnated with one matrix component and subsequently with at least one other matrix component. The first matrix component may predominantly comprise a substantially uncatalyzed component and the at least one other matrix component may predominantly comprise a substantially unreacted hardener component. Until the at least two components are combined, the tows impregnated with the at least two different matrix components have virtually infinite shelf life at room temperature. Only when at least two differently impregnated tows are combined during the composite fabrication process is an overall stoichiometrically correct matrix composition obtained to enable the final curing and hardening of the composite part.

### BACKGROUND OF THE INVENTION

1. Field of the Invention

The present invention relates generally to a process of pre-impregnating fibers and their use in the fabrication of composite structures. More specifically, the present invention relates to a method, apparatus, and system to impregnate fibers wherein at least two distinct but cooperative matrix or binder components are applied to separate dry fibers or bundles of fibers. A first matrix component may be primarily that of an uncatalyzed component and at least a second matrix component may be primarily that of an unreacted hardener component. Until combined, the fibers or bundles of fibers impregnated with the at least two different matrix components exhibit virtually infinite shelf life at room temperature. Only when at least two differently impregnated fibers or bundles of fibers are combined during a composite structure fabrication process is an overall stoichiometrically correct matrix composition obtained to effect the final curing and hardening of the composite structure.

2. State of the Art

Composite substances, obtained by different combinations of a reinforcement material (such as fibers, particles, or whiskers) in a matrix or binder material (such as polymer or epoxy resins, ceramics, or metals), are now widely used to fabricate composite structures in a variety of industries, including transport or military aircraft, appliances and business equipment, construction, consumer products, marine, land transportation, and others. A significant attribute of composite materials is their ability to replace conventional light-weight, high-strength metal or wood structure with an even lighter-weight, higher-strength alternative. In addition, composite structures may also be more susceptible to the design of some complex structural configurations, offer significant cost advantages with some manufacturing methods, and exhibit improved properties such as enhanced corrosion and wear resistance and increased fatigue life, in comparison to structures fabricated with conventional materials and techniques. Nevertheless, improving the manufacturing technology for composite structures is a significant challenge today in the field of composites and insight and innovation are required for continued progress and success.

Composite materials fabricated through the combination of a reinforcement fiber, either glass or carbon fibers, and a matrix or binder material are by far the most common. The most generally employed matrices or binders, also generally referred to as resin systems or simply resins, are of the polyester and epoxy type. Polyester matrices or binders are usually obtained from a vendor by the composite component fabricator as two components, and stored in an unmixed state until shortly before a time of anticipated use. A polyester resin and curing compound, fillers, and inhibitors are provided in one receptacle and the initiator in a separate receptacle. Epoxy matrices or binders, preferred for advanced composites because of their excellent adhesion, strength, low shrinkage, corrosion resistance, and many other properties, are also supplied as discrete and separate components. Epoxy resins are often used with diluents to alter the resin system's properties (such as viscosity, shelf and pot lives, and cost) and hardeners to reduce curing time and to also alter physical and mechanical properties of the epoxy resin system. The separate components in each of these polyester and epoxy binders are then mixed in the appropriate stoichiometry (i.e., the proper relative proportions or range of proportions in order to obtain the desired chemical reaction between the reactants) before applying them to the reinforcement fibers, using them to form a composite structure and using the appropriate curing procedures. Many of the compounds in polyester and epoxy binders or matrices are hazardous to humans and the environment when combined with other components, requiring special procedures when handling or disposing of them during the manufacturing of a composite component or structure. Further, when mixed and applied to the reinforcement fibers by conventional methods, the pot and shelf lives of the binder-impregnated fibers and fiber bundles are typically limited to at most thirty days.

Exemplary manufacturing or fabrication methods for composite components include manual or automated lay-up, filament winding, and pultrusion. In some instances, the fibers (such term also including bundles, tows and tapes) are impregnated or wetted with the binder or matrix material and the combination wound or laid on a mandrel or other forming structure, and then cured, as known in the art. Nonetheless, a somewhat better product can be made, with less matrix and fiber handling difficulty, by using a reinforcement fiber that has been pre-impregnated with a completed matrix or binder system and then cured slightly to facilitate handling. Such a fiber is commonly termed a “prepreg.” A prepreg is normally produced at a dedicated facility where the binder composition and fiber content is carefully controlled and then shipped to a composite-manufacturing facility. Most types of either polyester or epoxy resins are available in prepreg form.

Several critical problems and requirements exist in the manufacturing of composites. For example, in order to alleviate the problem associated with the fragility and abrasiveness of fibers during fabrication processes, a chemical coating has to be applied to the fibers so as to keep the individual fiber filaments together and for protection during handling. This chemical coating, most commonly known as sizing, is followed by a compatible finish coating. For certain applications, the sizing may need to be abraded or removed before finish coating. Other problems are associated with methods used to partially or completely mix binder or matrix systems in order to minimize or eliminate fabrication or storage problems.

For example, the current binder/fiber handling process is time critical and messy due to the tendency of the low viscosity ingredients to drip and contaminate surfaces. Ingredients in several of the binder or matrix systems are hazardous to human contact and unfriendly to the environment, and their disposal can result in hazardous exothermic reactions. Metering of binder content is imprecise and time consuming and migration of the binder during manufacturing causes relative binder content and fiber volume of an impregnated fiber to deviate from design requirements. Further, elevated temperature storage is often required for chemical components of the matrix or binder system, and some components must first be conditioned at high temperatures prior to use, resulting in manufacturing-schedule bottlenecks. In filament winding fabrication processes control of critical manufacturing steps, such as fiber band movement, is lacking because of the inability to control wet (binder-impregnated) wound band friction. Further, post-fabrication cleanup of winding tooling and operational areas is costly and time consuming and fiber winding speeds are limited because of the rate dependence of the current impregnation systems. In addition, disposal of mixed but unused matrix or binder systems can result in hazardous exothermic reactions. Nevertheless, the most significant problem in the manufacturing of composites heretofore has been the limited shelf or working life of prepregs and the very limited pot life (typically limited to a few hours) of partially or completely mixed binder or matrix systems prepared by conventional methods.

The inventor is aware of three conventional approaches used to extend the working life of prepregs, namely, solution-dilution impregnation, hot-melt impregnation, and the use of a chemorheologically tailored binder or matrix system.

In solution-dilution impregnation, the viscosity of a matrix resin is initially controlled by use of a solvent before impregnating the fiber with the diluted matrix resin. Once the fiber has been impregnated, the solvent is then removed by heating and evaporation before the prepreg is stored on spools. The additional processing cost, the need to recover the solvent and its associated environmental implications, and the inevitable solvent residue left in the matrix resin are significant problems associated with this technique.

In hot-melt impregnation, the viscosity of a matrix resin is initially controlled by heating before impregnating the fiber with the heated matrix resin. The resulting prepreg is then cooled and spooled. The additional processing cost, the need for the extra heating equipment, and the increase in matrix resin viscosity because of the heat-induced polymerization during impregnation are significant problems with this prepreg preparation technique.

Another common and significant limitation of both the solution-dilution and hot-melt impregnation techniques is the requirement that the prepreg must be stored under refrigerated conditions in order to control (impede) the curing process. Even under these expensive storage conditions the shelf life of some prepregs is only prolonged from a few hours to less than thirty days. The out time at room temperature of prepregs designed for cold storage must be carefully monitored to avoid exceeding the short use life.

Prepregs made by use of a chemorheologically tailored resin system have a working life that extends from thirty days to up to one year in normal, room-temperature conditions. This improvement in prepreg working life is accomplished by controlling the matrix viscosity profile through its chemical formulation rather than by the use of solvents or heated impregnation methods. The matrix viscosity is rather low during impregnation of the fiber to form a prepreg composition, which is immediately spooled during the same operation. After impregnation, chemical reactions in the matrix proceed only to the point at which the matrix viscosity achieves a higher level desired for the prepreg composition, thus allowing long storage periods at room temperature and a working life of up to one year. Subsequently, during fabrication of the composite part, optionally the prepreg's viscosity is again lowered by exposing it to heating or radiation. After the composite structure is formed, the piece is then cured. Although shelf and working lives are substantially increased by use of a chemorheologically tailored resin impregnation system compared to those obtained by use of solution-dilution and hot-melt impregnation methods, prepregs with an indefinite working life would clearly be desirable.

Accordingly, there is a need in the art to improve composite manufacturing procedures and prepreg preparation methods to provide essentially infinite shelf life (on the order of years, as opposed to the days, weeks, or months typical of the prior art) at ambient storage temperatures. Additionally, while achieving extended performance of shelf life, the need further exists to reduce or eliminate other, previously mentioned, composite fabrication-related problems. Such problems include, without limitation, deficiencies associated with imprecise resin content metering, matrix or binder migration during composite fabrication resulting in resin content and fiber volume deviating from design requirements, unduly low wet wound band friction resulting in fiber band movement, unduly limited fiber winding speeds attributable to rate dependence of conventional impregnation systems and contamination of the environment. Thus, it would be desirable to develop a fiber impregnation system enabling achievement of a desired balance of properties to control significant process parameters (e.g., manipulation of reaction kinetics to attain high temperature resistance, rapid cure behavior, and/or low temperature cure capability conventionally unobtainable within pot life and viscosity constraints of a processible binder or matrix system), develop a more uniform binder distribution, provide a higher volume fraction of fibrous reinforcement, improve industrial hygiene, and support high rate manufacturing of composite structures.

### BRIEF SUMMARY OF THE INVENTION

The present invention addresses these needs by providing single matrix component, fiber-impregnation method and system for use in a variety of fabrication methods of composite structures, such as, for example, filament winding, pultrusion, knitting, weaving, or extrusion coating. The inventive impregnation method and system comprises the application of at least one different component of a multi-component prepreg resin system as a matrix portion to each of at least two separate tows of dry fibers wherein the matrix portion of ihe first tow or ribbon may predominantly include an essentially uncatalyzed resin component and the matrix of the second tow or ribbon may predominantly include an essentially unreacted hardener component. The term “tow” as used herein encompasses, without limitation, any form, shape or grouping of one or more dry fibers supplied to and used in the different methods of composite fabrication, including without limitation filaments, strands, rovings, tapes, yarns, woven fabrics, or braidings. Until combined, the two differently impregnated tows, also termed “single component prepregs” herein, provide virtually infinite shelf life. During a composite structure fabrication process, the two differently impregnated tows are interleaved and intimately commingled to form an overall stoichiometrically correct matrix or binder composition, which is hardened after fabrication of the composite structure by use of conventional curing methods applicable to the particular choice of matrix composition employed. Fiber precursors in the form of fibers or groups of fibers impregnated with a single matrix component are also encompassed by the invention.

The present invention also includes methods and systems for fabricating composite structures using the single component prepregs as described above. In one such embodiment, at least two different but cooperative matrix or binder components are applied to separate tows of dry fibers and the resulting differently impregnated tows are commingled by the use of heat, pressure, ultrasonic vibrations or a combination of some or all of the foregoing before the resulting consolidated tow is applied to form a desired composite structure. In such method, any instigation of reacting matrix or binder components prior to consolidation of the tows and application to fabricate the composite structure is eliminated by application of the at least two different but cooperative resin components to separate tows from separate impregnation reservoirs, providing essentially infinite shelf life for the individual components and eliminating pot life limitations of conventional, pre-application mixed binders or matrices.

In another embodiment of a method and system for fabricating composite components using a variation of the single component prepreg approach of the present invention, a tow of dry fibers is sequentially impregnated with the first matrix component and subsequently with at least a second, different but cooperative matrix component by an appropriate process such as spray or by manifold impregnation. Impregnation with the at least a second matrix component may occur a significant time, up to and including years, after impregnation with the first matrix component. Advantages of this approach are that the design, operation, maintenance, and cleanup of process equipment is simplified due to the absence of reacting materials in the individual component streams. Additionally, pot life concerns of current wet fabrication methodologies are also eliminated. This fabrication method further allows the use of a dry fiber, eliminating the need for sizing during the fiber fabrication process by the inclusion of a hardener in the first matrix component.

In yet another embodiment of a method and system for fabricating composite components using the single component prepregs of the present invention, similar to the first embodiment disclosed herein above, the at least two different but cooperative matrix or binder components are applied to separate tows of dry fibers and the resulting differently impregnated tows are stored on separate storage spools either indefinitely or for a given, extended period of time, taking advantage of the indefinite shelf life of the single component prepregs. When fabrication of a composite structure is contemplated, the differently impregnated tows are retrieved from the storage spools and combined by the use of heat, pressure, ultrasonic vibrations or a combination of some or all of the foregoing before the resulting tow is used to form the desired composite part. This and other structures and forms of the present invention will become clearer from the following detailed description of the invention, the accompanying drawings, and the appended claims.

### BRIEF DESCRIPTION OF THE SEVERAL VIEWS OF THE DRAWINGS

In the drawings, which illustrate what is currently considered to be the best mode for carrying out the invention:

FIG. 1 is a perspective, semi-schematic view of an apparatus exemplifying a first embodiment of the present invention used in a filament winding fabrication process.

FIG. 2 is a schematic view of an apparatus exemplifying a second embodiment of the present invention used in a filament winding fabrication process.

FIG. 3 is a schematic view of an apparatus exemplifying a third embodiment of the present invention used in a filament winding fabrication process.

FIG. 4 is a schematic of a composite fabrication system, which includes a fiber system incorporating the two-part fiber-impregnation method of the present invention.

FIG. 5 is a schematic of a prototype apparatus for forming a composite structure in accordance with the present invention.

### DETAILED DESCRIPTION OF THE INVENTION

The present invention comprises a single matrix component, fiber-impregnation method and system suitable for use in fabrication of composite structures. The method and system uses a multiple-part or multiple-component matrix system wherein each of at least two different but cooperative matrix components is applied to one of at least two different tows of dry fibers, wherein the matrix system applied to a first tow of fibers may predominantly include a substantially uncatalyzed resin component and the matrix or binder system applied to a second tow of fibers may predominantly include a substantially unreacted hardener component. The at least two separate matrix components before commingling may be referred to herein as a “matrix precursor” for convenience. A variation of the method and system includes applying one of the at least two matrix components to a tow and then subsequently applying the at least one other matrix component.

It should be noted that the terms “matrix system,” “binder system,” “matrix resin system,” “binder resin system,” “matrix blend,” “binder blend,” or “resin” are used herein as synonymous terms as also done in the applicable art, referring sometimes to a matrix or binder composition containing only a resin component, a hardener component, or an adduct of resin and hardener components with varying amounts of each.

In describing the exemplary embodiments of the present invention, similar elements and features in different figures of the drawings are identified by similar reference numerals.

The chemical composition of the first matrix component may include a predominant amount of resin, ranging from 0% (by weight) hardener to an adduct of resin and hardener that is less than the stoichiometric proportions required for the first matrix to harden and cure. The chemical composition of the second matrix contains a predominant amount of hardener, ranging from 0% (by weight) resin to an adduct of hardener and resin that is less than the stoichiometric proportions required for the second matrix to harden and cure. Thus, it is understood that the term “single component” when applied to impregnation of a tow, may refer to a matrix component formulation which includes not only a predominant component but also at least another, different but cooperative component in less than stoichiometric (“off-stoichiometric”) proportions. The two different single component prepregs may be color-coded for easy identification by simply adding different coloring agents to the matrix component formulations. Also, the viscosities of each matrix component may be tailored to provide the necessary properties (such as, for example, tackiness, web strength, and friction between the impregnated fiber and a fabrication tool) needed for controlled prepreg delivery and storage stability in any given fabrication process. Until combined, the two single component prepregs prepared by the method disclosed herein provide virtually infinite shelf life. During the composite structure fabrication process, the two differently impregnated single component prepregs are interleaved and intimately commingled to form an overall stoichiometrically correct matrix or binder system, enabling curing and hardening to be effected. Of course, more than two single component prepregs, each impregnated with a mutually different matrix component formulation, may be employed in practicing the invention. Thus, for example, three or more differently impregnated single component prepregs may be interleaved and intimately commingled to form an overall stoichiometrically correct matrix or binder system, enabling curing and hardening to be effected. The terms “composite fabrication process,” “fabrication process,” or “composite manufacturing process” are used herein broadly to include different processes or methods of composite structure fabrication, including, as for example, filament winding, pultrusion, knitting, weaving, or extrusion coating.

Both single component pre-impregnated tows may be formed by any conventional, off-line, prepreg manufacturing processes. Online processes may also be employed including applying each of the at least two matrix components to a different tow of dry fibers by, for example, passing them through different resin baths and then combining the tows or, alternatively, applying one of the matrix components to a tow by running it through a resin bath and then applying another matrix component sequentially to the same tow as by spray or manifold impregnation, prior to fabrication of the composite structure. It is notable that, with either approach, design, operation, maintenance and clean up of process equipment is significantly simplified due to absence of reacting materials in the individual component streams. Further, pot life concerns associated with conventional “wet” filament winding techniques are eliminated.

The matrix resin system ingredients may include components from the following chemical families: polyesters, epoxies, anhydrides, amines, Lewis acid catalysts, imidazoles, cyanate esters, bismaleimides, or phenolic triazines. The fibers used in the present invention may be fabricated from glass, carbon or graphite, or an organic material such as, for example, an aramid (e.g., Kevlar®), polybenzoxazole (PBO) or polyethylene. Other suitable fibers include silicon carbide (SiC).

An exemplary matrix of the present invention may be an epoxy-amine system. The first matrix component may include a blend of epoxy resins, such as, for example, TACTIX 742 (trisepoxy novolac), TACTIX 556 (dycyclopentadiene-backboned novolac epoxy), MY510 (triglycidyl ether of paraminophenol), and PT-810. One source for the foregoing ingredients is Vantico, headquartered in Basil, Switzerland and also having an office in Los Angeles, Calif., U.S.A. The second matrix component may include liquid and solid aromatic polyamines. The viscosities of each of the two matrix components of the exemplary matrix may be made more “processible” by adducting each with a small percentage, for example, up to about 16% of normal stoichiometric amount, of the other. Once the adducts have gone to completion, shelf life is infinite until the two matrix components are commingled.

Alternatively, the matrix resin system may be comprised of EPON™ Resin 862 and EPI-CURE™ Curing Agent W, offered commercially by Resolution Performance Products of Houston, Tex., U.S.A. An ultimate mix ratio of 100:26.4 parts by weight of these components may be achieved by pre-blending from aero to about 20% of each in the other to provide desired handling characteristics and adjusting resin content of the resulting “Part A” and “Part B” components to achieve the stoichiometric ratio when combined.

As another alternative, the matrix resin system may be comprised of EPON™ Resin 826 and EPI-CURE® Curing Agent 9551, the components again being offered by Resolution Performance Products. An ultimate mix ratio of 100:36 parts by weight of each of these components may be achieved by pre-blending from zero to about 16% each in the other to provide desired handling characteristics and adjusting resin content of the resulting “Part A” and “Part B” components to achieve the stoichiometric ratio when combined.

The above-listed matrix resin systems are illustrative of, but not limiting as, suitable compositions; alternatively, the matrix resin system may consist of any two or more chemical components that can be physically separated into a “Part A” and “Part B” or even more than two off-stoichiometric blends ranging from zero to 100% of an ultimate stoichiometric or targeted mix ratio. Thus, the present invention contemplates not only the use of more than two off-stoichiometric blends but also of more than two fibers, each impregnated with one of the more than two off-stoichiometric blends.

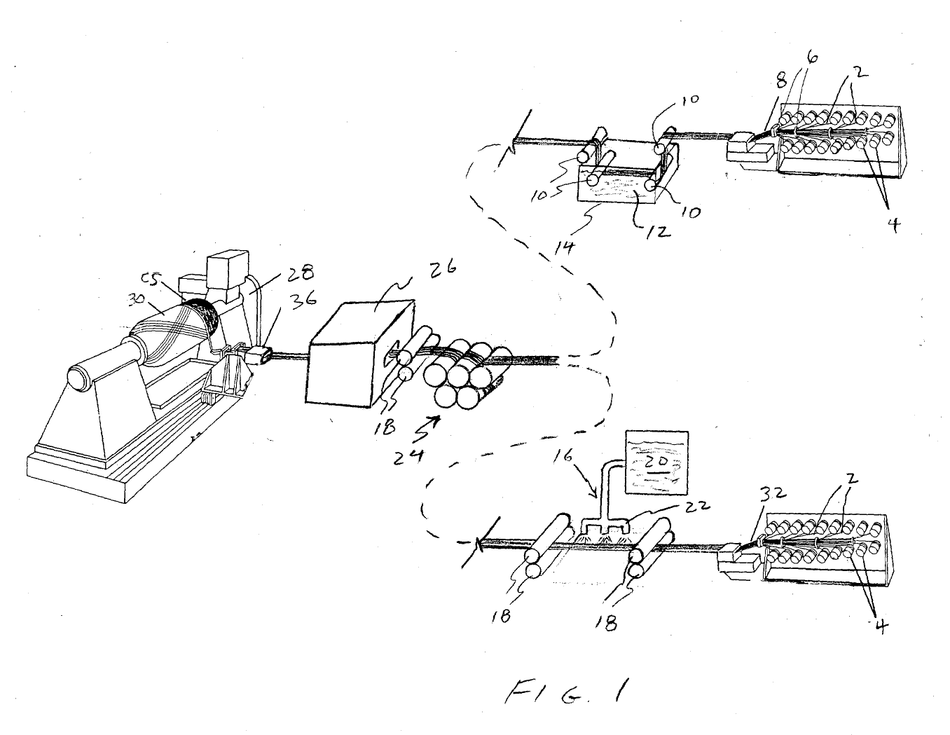

The present invention also includes methods of fabricating composite structures using the single component prepregs as described. A perspective, semi-schematic view of the first exemplary method and system for a filament winding fabrication process is depicted in FIG. 1. Such embodiment includes a plurality of dry fibers 2 that are fed from a plurality of fiber spools 4 through a plurality of feeding elements 6 to form a tow of dry fibers 8. The tow of dry fibers 8 is fed by a plurality of guide rolls 10 for wet impregnation in a resin tank 14, which contains the first matrix component formulation 12. Simultaneously, another similarly-fabricated tow of dry fibers 32 is fed under tension by a two pairs of puller rolls 18 into and across a resinator 16 and impregnated by spraying the second matrix component formulation 20 from spray manifold 22. The separate tows of dry fibers 8 and 32 are then combined in an S-type guide roll assembly 24, fed into a commingling chamber 26 by another plurality of puller rolls 18, and commingled together by the use of heat, pressure, ultrasonic vibrations or a combination of some or all of the foregoing. The resulting consolidated tow of fibers 34 is then supplied to a conventional filament winding tool 36 (details not shown) of a filament winding machine 28 and wrapped over a mandrel 30 to form the desired composite structure CS. Several modifications to this exemplary embodiment will be understood and appreciated by one of ordinary skill in the art. For example, there is no requirement that the first matrix component formulation 12 be applied to tow of dry fibers 8 in a resin tank 14 and the second matrix component formulation be applied to tow of dry fibers 32 in a resinator 16. Depending on the requirements of the particular fabrication method used, both tows of dry fibers 8 and 32 may be impregnated in resinators 16 or resin tanks 14 or by use of any other conventional matrix resin application apparatus and technique known in the art.

In comparison to the prior art, several advantages are provided by the foregoing embodiment of the present invention. First, an undesirably early reaction of matrix components is eliminated by use of the (by way of example) two matrix resin component formulations from separate impregnation reservoirs, and essentially infinite matrix component shelf life is obtained. Further, fabrication of the composite structure may be stopped as desired for any length of time during the winding or other fabrication process without any detrimental effect to the quality of the final composite structure, resulting in increased quality control because each individual tow can be inspected after impregnation and before commingling and a better final structure achieved by carefully monitoring, controlling, and changing (if required or desired) the matrix component and thus the overall matrix formulation during fabrication. Thus, different portions or layers of a composite structure may be advantageously formed with different properties. The ability to better control the viscosity of the matrix by changing the mixture composition (e.g., the percent of resin) also enables maintenance of an acceptable level of friction to reduce sliding of the consolidated tow 34 with respect to the filament winding tool 36, again increasing productivity levels. Further, for filament winding processes that use very expensive matrix elements, such, as for example, those used in the filament winding of rocket motor cases, the ability to start and stop the winding operation at will may result in a significant reduction in manufacturing costs.

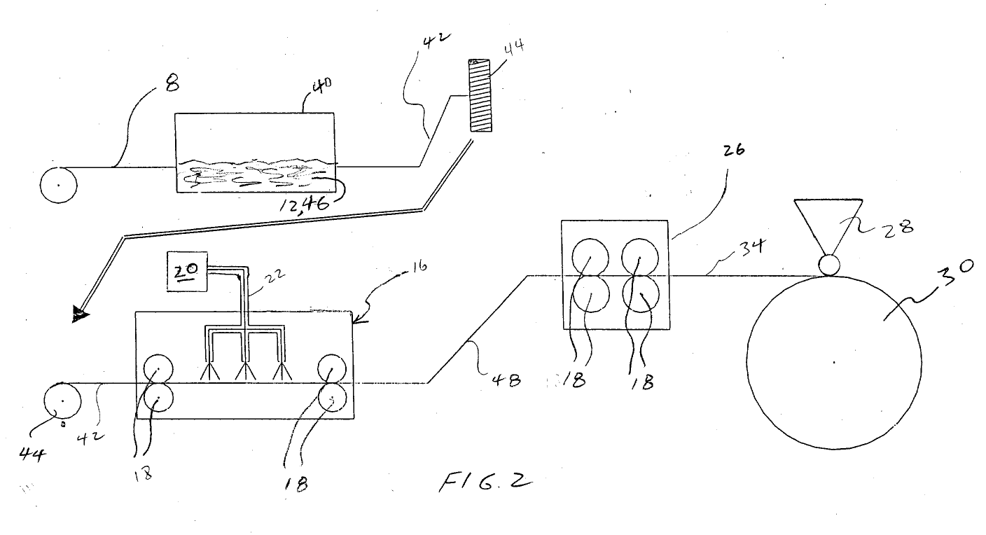

A schematic view of another exemplary embodiment of a fabrication method and system using the present invention is shown in FIG. 2 for a filament winding fabrication process. Such embodiment includes application of first and second matrix components by a semi-wet process, wherein a high-sized tow 42 is created by applying either the first or the second matrix component 12 or 20 and, for example the second matrix component 20 in the form of a hardener as a sizing 46 to a tow of dry fibers 8 in a sizing bath 40 as a high concentration level sizing in lieu of conventional sizing (which is typically applied at a concentration level of about 0.3% to 2.0% by weight) at a concentration level ranging from about 1% by weight up to about 40% by weight. The sizing bath 40 function and operation may be similar to the that disclosed in the form of resin tank 14 of FIG. 1. It is notable that the sizing bath 40 may be located at a fiber manufacturing facility rather than at a point of use. The resulting high-sized tow 42 may then be optionally stored in a storage spool 44 at room temperature until needed, or if high-sized tow 42 is produced by a fiber manufacturer, shipped to the point of use. At the time the high-sized tow 42 is required for fabrication of a composite structure, the high-sized tow 42 is then disbursed from a storage spool 44, impregnated with the other matrix component (for example, a first matrix component in the form of a substantially uncatalyzed resin (or, if high-sized tow 42 has previously been impregnated with a resin, with a substantially unreacted hardener) in resinator 16 to form a dual matrix component tow 48, further processed in the commingling chamber 26 by the use of heat, pressure, ultrasonic vibrations or a combination of some or all of the foregoing to form a consolidated tow 34, fed to a filament winding machine 28 and wound on mandrel 30 as disclosed in FIG. 1 in connection with the first exemplary embodiment. It is understood that such fabrication procedures result in simplified operations by eliminating resin system premixing, eliminating scrap of chemically advanced resin from the impregnation bath, and by eliminating the need for sizing solution conventionally applied by fiber manufacturers to facilitate fiber handling. The effect of these simplifying steps include simplification of the design, operation, maintenance, and cleanup of process equipment due to the absence of reacting materials in the individual component streams. Further, the pot life concerns of current wet filament winding methodologies are eliminated. As also noted in the description of the first embodiment of the present invention, there are no requirements that the first matrix formulation 12 be applied in a sizing bath 46 and the second matrix formulation in a resinator 16. Depending on the requirements of the particular fabrication method used, both the tow of dry fibers 8 and resulting high-sized tow 42 may be impregnated in resinators 16 or sizing baths 46 or by use of any other matrix resin application technique known in the art.

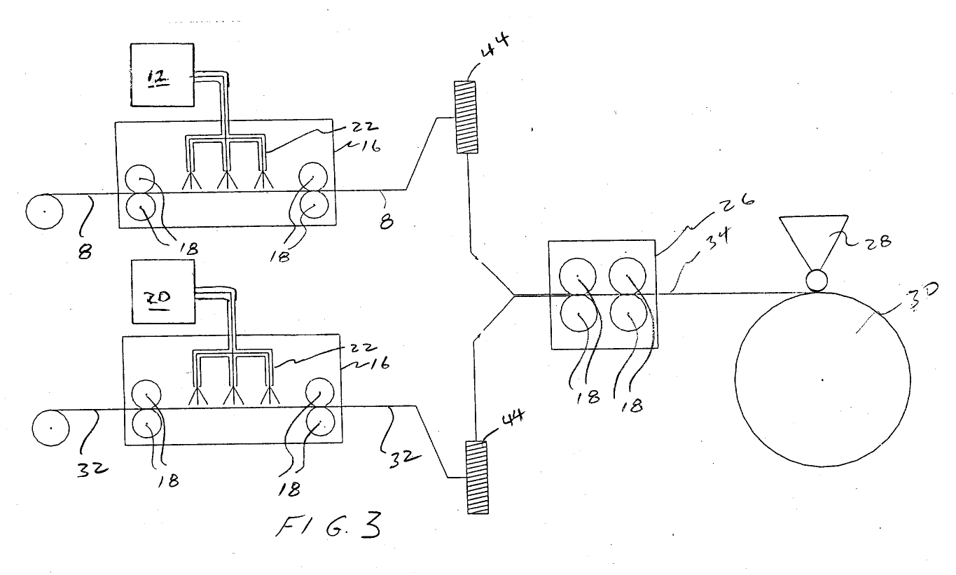

A schematic view of yet another exemplary embodiment of a fabrication method and system using the present invention is shown in FIG. 3 in the context of a filament winding fabrication process. This embodiment includes a dry filament winding approach in which both a first (resin) and second (hardener) matrix components 12, 20 of the matrix system are each first applied to separate tows of dry fibers 8 and 32 as described in the embodiment of FIG. 1. However, unlike in the method described with respect to FIG. 1, the single component-impregnated tows 8 and 32 may each be optionally stored indefinitely on storage spools 44 at ambient temperature until needed for filament winding of a composite structure. At the time of composite structure fabrication, the dry, respectively differently impregnated tows 8 and 32 fed from the storage spools 44 are first commingled in a commingling chamber 26 to form a consolidated tow 34 by the use of heat, pressure, ultrasonic vibrations or a combination of some or all of the foregoing and wound using a filament winding machine 28 on mandrel 30 as depicted in FIG. 1 in connection with the first exemplary embodiment. The physical separation of reactive components in the resin system provides essentially infinite shelf life, eliminating the cost and schedule impact of low temperature storage (typically about 0° F.) required by conventional prepregs. Elimination of the need for resin mixing and continuous resin metering further simplifies and accelerates winding operations and improves the fabrication of composite components over conventional wet filament winding because the higher viscosity of the resin system reduces the tendency for placed fibers to wrinkle due to changing resin volume in the part and movement due to lack of fiber restraint.

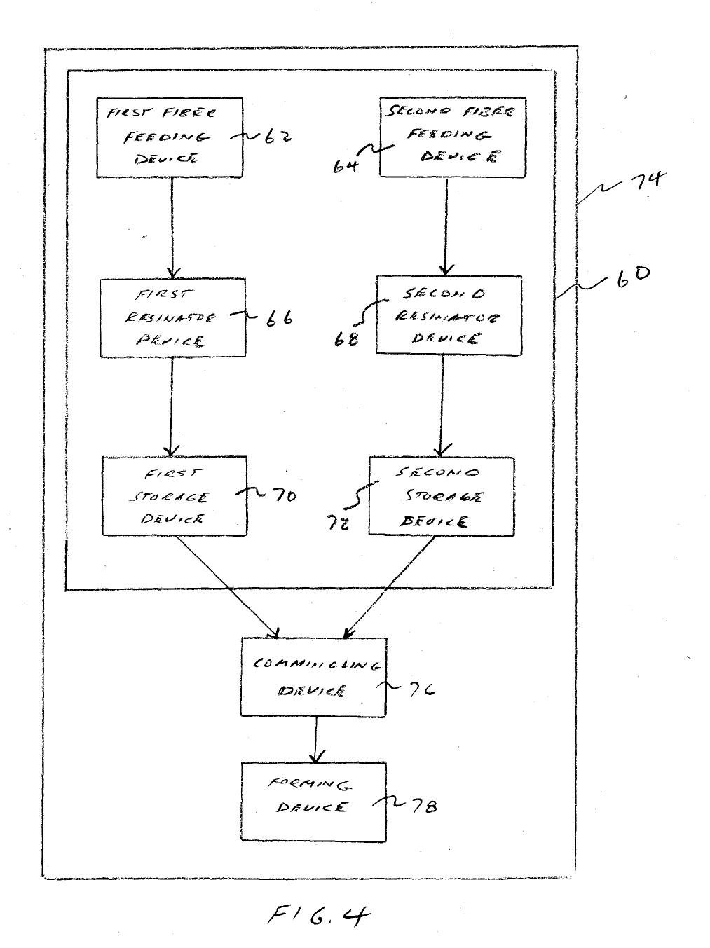

Referring now to the drawing of FIG. 4, a schematic is shown of a composite structure manufacturing system 74, which includes a fiber system 60 incorporating the two-part or single component method of impregnating fibers of the present invention. In the fiber system 60, fibers from a first fiber feeding device 62 are impregnated with a first matrix component formulation in a first resinator device 66 and stored in the first storage device 70. Similarly, fibers from the second feeding device 64 are impregnated with a second matrix component formulation in the second resinator device 68 and stored in the second storage device 72. Because of the off-stoichiometric formulations used in the first and second matrix components there are no limitations on the storage time in both the first and second storage devices 70 and 72 even if both are maintained at room temperature. After impregnation and when needed for fabrication of a composite structure, the differently impregnated fibers from both storage devices 70 and 72 are combined in the commingling device 76 by the use of conventional commingling methods, including the use of heat, pressure, ultrasonic vibrations or a combination of some or all of the foregoing, before the resulting consolidated fiber is used in the forming device 78 for the fabrication of the desired composite structure using any conventional composite fabrication methods including without limitation those mentioned herein above. Variations of the composite manufacturing system 74 and fiber system 60 shown in FIG. 4 should be understood by persons of ordinary skill in the art to include not only systems to implement the other embodiments disclosed herein but others as well.

### EXAMPLE

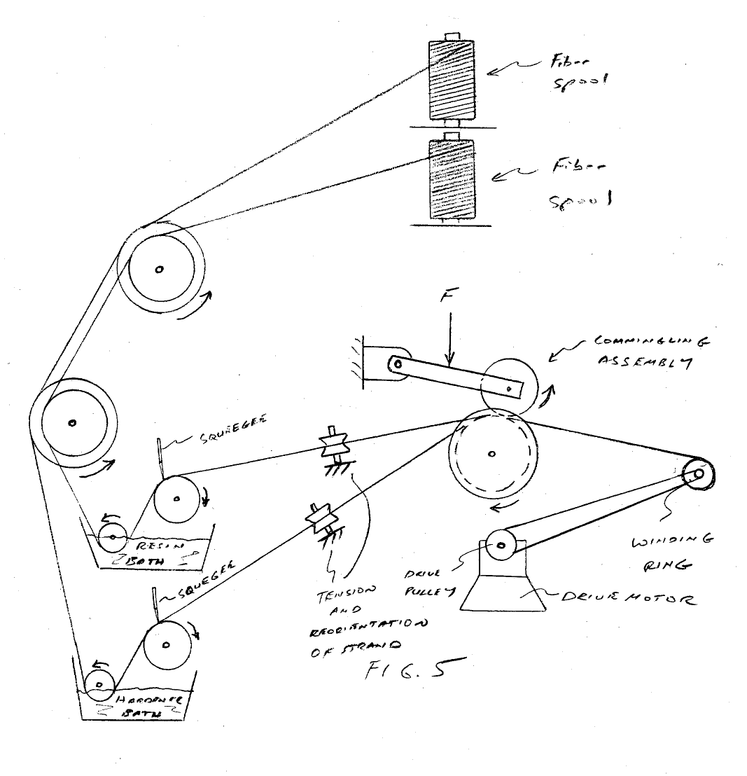

A sample composite structure was fabricated according to a simplified version, illustrated schematically in FIG. 5, of the apparatus of the embodiment of FIG. 1 of the present invention, using an epoxy resin and an amine hardener. The “Part A” component of the matrix resin system consisted of a modified epoxy resin (a blend of 80:20 parts by weight of the diglycidyl ether of bisphenol A in the form of EPON™ 826 epoxy resin from Resolution Performance Products of Houston, Tex., U.S.A. and the diglycidyl ether of 1, 4-butanediol in the form of Araldite RD-2 from Vantico Inc. of Brewster, New York, U.S.A.) and a eutectic blend of aromatic diamines in the form of TONOX® 60/40, offered by Crompton Corporation of Greenwich, Connecticut, U.S.A. pre-blended in the ratio of 90.287:9.713 parts by weight. The “Part B” component of the matrix resin system consisted of the above-described modified epoxy resin and eutectic blend of aromatic diamines pre-blended in the ratio of 63.063:36.937 parts by weight. The “Part A” component was applied to one tow of dry IM7-type carbon fiber (manufactured by Hexcel Corporation) to a resin content of 42.0±2.0% by weight. The “Part B” component was applied to another tow of IM7-type carbon fiber to a resin content of 26.0±1.5% by weight. The tows were consolidated under pressure and wound on a winding ring to provide a test sample. A control sample was also formed on a winding ring using a conventional wet-wind, online process impregnating a tow of the same fiber with a stoichiometric mixture of the same resin and hardener pre-blended in the ratio of 123.5:31.0 parts by weight. The samples were tested by standardized techniques known in the industry (NOL ring horizontal shear per ASTM D-2344; glass transition temperature by dynamic mechanical spectroscopy using Rheometrics Scientific RDS Model 7700; and fiber volume, void volume and resin content by Alliant Aerospace procedure 25000DT12033 (“Determination of Resin Content, Fiber and Void Volume in Epoxy/Graphite Composites by Acid Digestion”), consistent with SACMA (Suppliers of Advanced Composite Materials Association) procedure SRM 23R-94 (“Determination of Resin Content and Fiber Areal Weight of Thermoset Prepreg with Destructive Techniques”)). The following results were produced:

| Test | | | |
|---|---|---|---|
| Parameter | Control Sample | Inventive Sample | Test Purpose |
| Short beam | 7350 psi | 8400 psi | Tests resin properties |
| shear | | | |
| Glass | 130°(266° F.) | 125° C.(257° F.) | Tg is sensitive to mix |
| Transition | | | ratio - higher Tg is |
| temperature | | | desirable. Production |
| (Tg) | | | limits are 120-140° C. |
| Fiber | 59.26 | 63.12 | Measures laminate |
| Volume (%) | | | quality |
| Void | 2.53 | 0.99 | Measures laminate |
| Volume (%) | | | quality |
| Resin | 30.87 | 28.25 | Measures laminate |
| content (%) | | | quality |

Thus, it will be appreciated that the inventive sample exhibits a higher shear strength in short beam shear as well as a superior laminate quality in terms of a higher fiber volume, lower resin content and significantly reduced void volume. Tg, while lower for the inventive sample, is similar to that of the control sample and this characteristic may be adjusted by modifying resin/hardener mix ratio and/or modifying the process to change the extent of commingling of Part A and Part B.

It should be emphasized that an optimal off-stoichiometric ratio depends on the resin system. Due to limitations of the impregnation apparatus employed in the above example, low resin contents (less than 20% by weight) could not be applied reliably, so it was necessary in that specific instance to blend a portion of “Part A” with “Part B.” Furthermore, in some cases, the physical and chemical characteristics of the ingredients might necessitate blending components of a resin system. Despite such considerations, it may be concluded that 0:100 and 100:0 are the theoretically ideal ratios for a two part impregnation system.

It should be noted that the present invention, in addition to enabling variations of the resin composition during, for example, a winding operation, facilitates the substitution of one type of impregnated fiber for another in various layers of a composite structure. For example, a rocket motor case wind may commence with rubber, followed by a graphite epoxy and subsequently with a thermal insulative layer of cork. This invention facilitates supplanting the current structure with an integrated structure fabricated at a single manufacturing station with various functional components of resins and fibers applied by a two-part or even greater multi-part component winding.

The present invention, due to the enhanced transportability of the inventive impregnation methods and systems as well as that of the single component impregnated fibers produced therewith, is also suitable for expansion of composite material fabrication techniques to nontraditional applications. For example, components of bridge structures may be easily fabricated, due to the less stringent requirements for resins and more forgiving mix ratios for such commercial applications. Other stationary structures, such as silos and structural columns may also become more commercially feasible. In addition, the present invention facilitates on-site repair or reinforcement of both stationary and mobile structures. For example, bridge and building columns may be strengthened against earthquake loads to upgrade to more stringent seismic requirements or to avoid a teardown and replacement of a substandard structure by improving it in situ. Aircraft components such as wings, fuel tanks, and fuselages may also be repaired using the present invention in a mobile repair facility. Components for land vehicles may also be more desirably fabricated in commercial quantities and at lower costs in comparison to conventional composite fabrication techniques due to the lower capital investment and materials costs enabled by the present invention.

Although exemplary embodiments and details thereof have been explained herein to disclose the current best modes of the present invention as applied to fabrication of composite components, it will be understood by those persons of ordinary skill in the applicable arts that several changes and variations in the methods, apparatus and systems disclosed herein may be implemented within the scope of the present invention for use in filament winding or other fabrication composite structure fabrication methods such as, for example, pultrusion, knitting, weaving, or extrusion coating. The scope of the invention is defined by the claims appended below, particularly pointing out and distinctly claiming the subject matter which the inventor regards as his invention.

What is claimed is:

1. A method of forming a fiber system for use in the fabrication of composite structures, the method comprising:
providing a matrix precursor in the form of a first matrix component and at least a second, different but cooperative matrix component, the first and at least a second matrix components formulated to form, when commingled, a stoichiometrically effective matrix enabled to cure and harden;
providing at least two tows of fibers;
applying to at least a first tow of the at least two tows of fibers a first matrix component comprising a substantially uncatalyzed resin component; and
applying to at least a second tow of the at least two tows of fibers at least a second matrix component comprising a substantially unreacted hardener component.

2. The method of claim 1, further comprising selecting the first matrix component to comprise a substantially uncatalyzed resin component and the at least a second matrix component to comprise a substantially unreacted hardener component.

3. The method of claim 2, further comprising formulating the first matrix component to comprise an amount of the resin component and, optionally, an amount of the hardener ranging from 0% of the hardener component to an adduct of the resin and the hardener components in less than stoichiometric proportions required to enable the matrix to harden and cure, and formulating the at least a second matrix component to comprise an amount of the hardener component and, optionally, an amount of the resin component ranging from 0% of the resin component to an adduct of the hardener and the resin components in less than stoichiometric proportions required to enable the matrix to harden and cure.

4. The method of claim 1, further comprising selecting the fibers from glass fibers, carbon fibers, and organic fibers.

5. The method of claim 1, further including selecting the matrix components from polyesters, epoxies, anhydrides, amines, Lewis acid catalysts, imidazoles, cyanate esters, bismaleimides and phenolic triazines and combinations thereof.

6. A method of fabricating a composite structure, comprising:
providing a matrix precursor in the form of a first matrix component and at least a second, different but cooperative matrix component, the first and the at least a second matrix components formulated to form, when commingled, a stoichiometrically effective matrix enabled to cure and harden;
providing at least two tows of fibers;
applying to at least a first tow of the at least two tows of dry fibers the first matrix component;
applying to at least a second tow of the at least two tows of dry fibers the at least a second matrix component;
commingling the at least first and second tows to which the first matrix component and the at least a second matrix component have been applied into at least one consolidated tow; and
using the at least one consolidated tow to form a composite structure.

7. The method of claim 6, further comprising selecting the first matrix component to comprise a substantially uncatalyzed resin component and the at least a second matrix component to comprise a substantially unreacted hardener component.

8. The method of claim 7, further comprising formulating the first matrix component to comprise an amount of the resin component and, optionally, an amount of the hardener ranging from 0% of the hardener component to an adduct of the resin and the hardener components in less than stoichiometric proportions required to enable the matrix to harden and cure, and formulating the at least a second matrix component to comprise an amount of the hardener component and, optionally, an amount of the resin component ranging from 0% of the resin component to an adduct of the hardener and the resin components in less than stoichiometric proportions required to enable the matrix to harden and cure.

9. The method of claim 7, further comprising selecting the fibers from glass fibers, carbon fibers, and organic fibers.

10. The method of claim 6 further comprising, before commingling the at least first and second tows to which the first matrix component and the at least a second matrix component have been applied into at least one consolidated tow, storing at least one of the at least first and second tows off-line on a storage spool before forming the composite structure.

11. The method of claim 10, further including storing the at least one of the at least first and second tows at ambient temperature.

12. The method of claim 6, further including selecting the matrix components from polyesters, epoxies, anhydrides, amines, Lewis acid catalysts, imidazoles, cyanate esters, bismaleimides, and phenolic triazines and combinations thereof.

13. A method of fabricating a composite structure, comprising:
providing a matrix precursor in the form of a first matrix component and at least a second, different but cooperative matrix component, the first and the at least a second matrix components formulated to form, when commingled, a stoichiometrically effective matrix enabled to cure and harden;
providing at least one tow of dry fibers;
applying to the at least one tow of dry fibers one of the first and the at least a second matrix components to form at least one high-sized tow of fibers;
applying another of the first and the at least a second matrix components to the at least one high-sized tow of fibers to provide a tow having commingled first and second matrix components; and
using the tow having the commingled first and at least a second matrix components to form a composite structure.

14. The method of claim 13, further comprising selecting the first matrix component to comprise a substantially uncatalyzed resin component and the at least a second matrix component to comprise a substantially unreacted hardener component.

15. The method of claim 14, further comprising formulating the first matrix component to comprise an amount of the resin component and, optionally, an amount of the hardener ranging from 0% of the hardener component to an adduct of the resin and the hardener components in less than stoichiometric proportions required to enable the matrix to harden and cure, and formulating the at least a second matrix component to comprise an amount of the hardener component and, optionally, an amount of the resin component ranging from 0% of the resin component to an adduct of the hardener and the resin components in less than stoichiometric proportions required to enable the matrix to harden and cure.

16. The method of claim 13 further comprising, before applying another of the first and the at least a second matrix components to the at least one high-sized tow of fibers, storing the at least one high-sized, pre-impregnated tow of fibers off-line on a storage spool.

17. The method of claim 16, further comprising storing the at least one high-sized tow of fibers at room temperature.

18. The method of claim 14, further comprising formulating the one of the first and the at least a second matrix components to have a concentration level ranging from about 1% up to about 40% by weight.

19. The method of claim 13, further comprising selecting the fibers from glass fibers, carbon fibers, and organic fibers.

20. The method of claim 13, further including selecting the matrix components from polyesters, epoxies, anhydrides, amines, Lewis acid catalysts, imidazoles, cyanate esters, bismaleimides and phenolic triazines and combinations thereof.

21. An apparatus for forming a fiber system for use in the fabrication of composite structures, comprising:
a source of a first matrix component;
at least another source of at least a second, different but cooperative matrix component;
wherein the first and the at least a second matrix components are formulated to form, when commingled, a stoichiometrically effective matrix enabled to cure and harden;
a first impregnation assembly configured to receive at least one tow of fibers, to apply the first matrix component to the at least first tow of fibers and to deliver the at least first tow of fibers to at least one storage spool after the application of the first matrix component; and
at least a second impregnation assembly configured to receive at least a second tow of fibers, to apply the at least a second matrix component to the at least second tow of fibers and to deliver the at least a second tow of impregnated fibers to at least a second storage spool after the application of the at least a second matrix component.

22. The apparatus of claim 21, wherein the first matrix component comprises a substantially uncatalyzed resin component and the at least a second matrix component comprises a substantially unreacted hardener component.

23. The apparatus of claim 22, wherein the first matrix component is formulated to comprise an amount of the resin component and, optionally, an amount of the hardener ranging from 0% of the hardener component to an adduct of the resin and the hardener components in less than stoichiometric proportions required to enable the matrix to harden and cure, and the at least a second matrix component is formulated to comprise an amount of the hardener component and, optionally, an amount of the resin component ranging from 0% of the resin component to an adduct of the hardener and the resin components in less than stoichiometric proportions required to enable the matrix to harden and cure.

24. The apparatus of claim 21, wherein the fibers comprise glass fibers, carbon fibers, or organic fibers.

25. The apparatus of claim 21, wherein the first and the at least a second matrix components are comprised of epoxies, anhydrides, amines, Lewis acid catalysts, imidazoles, cyanate esters, bismaleimides, or phenolic triazines and combinations thereof.

26. The apparatus of claim 21, further including a room temperature storage environment for the spools.

27. An apparatus for use in fabricating a composite structure, comprising:
a source of a first matrix component;
at least another source of at least a second, different but cooperative matrix component;
wherein the first and the at least a second matrix components are formulated to form, when commingled, a stoichiometrically effective matrix enabled to cure and harden;
a first assembly configured to receive at least a first tow of fibers, to apply the first matrix component to the at least first tow of fibers;
at least a second assembly configured to receive at least a second tow of fibers, to apply the at least a second matrix component to the at least a second tow of fibers;
a commingling assembly configured to commingle a plurality of tows;
a forming assembly configured to receive at least one commingled fiber from the commingling assembly and apply the at least one commingled fiber to form a composite structure.

28. The apparatus of claim 27, wherein the first matrix component comprises a substantially uncatalyzed resin component and the at least a second matrix component comprises a substantially unreacted hardener component.

29. The apparatus of claim 28, wherein the first matrix component is formulated to comprise an amount of the resin component and, optionally, an amount of the hardener ranging from 0% of the hardener component to an adduct of the resin and the hardener components in less than stoichiometric proportions required to enable the matrix to harden and cure, and the at least a second matrix component is formulated to comprise an amount of the hardener component and, optionally, an amount of the resin component ranging from 0% of the resin component to an adduct of the hardener and the resin components in less than stoichiometric proportions required to enable the matrix to harden and cure.

30. The apparatus of claim 27, further comprising at least two storage spools, each configured to store thereon at least one tow having the first or the at least a second component applied thereto prior to delivery to the commingling assembly.

31. The apparatus of claim 30, further comprising an ambient temperature spool storage environment.

32. The apparatus of claim 27, wherein the fibers comprise glass fibers, carbon fibers, or organic fibers.

33. The apparatus of claim 27, wherein the first and the at least a second matrix components are comprised of polyesters, epoxies, anhydrides, amines, Lewis acid catalysts, imidazoles, cyanate esters, bismaleimides, or phenolic triazines and combinations thereof.

34. An apparatus for use in fabricating a composite structure, comprising:
a source of a first matrix component;
at least another source of at least a second, different but cooperative matrix component;
wherein the first and the at least a second matrix components are formulated to form, when commingled, a stoichiometrically effective matrix enabled to cure and harden;
a first assembly configured to receive at least one tow of fibers, to apply to the at least first tow of fibers a high-sizing matrix comprising one of the first and the at least a second matrix components to form at least one high-sized tow of fibers;
at least a second assembly configured to receive the at least first high-sized tow of fiber and to apply at least another of the first and the at least a second matrix components thereto; and
a fabrication assembly configured to receive the at least one high-sized tow of fiber having the first and second matrix components applied thereto and to apply the at least one high-sized tow of fiber having the first and the at least a second matrix components applied thereto to form a composite structure.

35. The apparatus of claim 34, wherein the first matrix component comprises a substantially uncatalyzed resin component and the at least a second matrix component comprises a substantially unreacted hardener component.

36. The apparatus of claim 35, wherein the first matrix component is formulated to comprise an amount of the resin component and, optionally, an amount of the hardener ranging from 0% of the hardener component to an adduct of the resin and the hardener components in less than stoichiometric proportions required to enable the matrix to harden and cure, and the at least a second matrix component is formulated to comprise an amount of the hardener component and, optionally, an amount of the resin component ranging from 0% of the resin component to an adduct of the hardener and the resin components in less than stoichiometric proportions required to enable the matrix to harden and cure.

37. The apparatus of claim 34, further comprising at least one storage spool configured to store the at least first high-sized tow of fibers having the one of the first and the at least a second matrix components applied thereto before application of the at least another of the first and the at least a second matrix components.

38. The apparatus of claim 37, further comprising an ambient temperature storage spool environment.

39. The apparatus of claim 35, wherein the one of the first and the at least a second matrix components has a concentration level ranging from about 1% up to about 40% by weight.

40. The apparatus of claim 34, wherein the fibers comprise glass fibers, carbon fibers, or organic fibers.

41. The apparatus of claim 34, wherein the first and the at least a second matrix components are comprised of polyesters, epoxies, anhydrides, amines, Lewis acid catalysts, imidazoles, cyanate esters, bismaleimides, or phenolic triazines and combinations thereof.

42. A system for producing a matrix precursor having an extended shelf life, comprising:
a source of a first matrix component;
at least another source of at least a second, different but cooperative matrix component;
wherein the first and the at least a second matrix components are formulated to form, when commingled, a stoichiometrically effective matrix enabled to cure and harden;
at least two fiber sources;
at least two fiber storage elements, each configured for storage of at least one tow of fibers;
a first assembly configured to apply the first matrix component from the source to fibers from at least one of the at least two fiber sources and to deliver fibers having the first matrix component applied thereto to a fiber storage element; and
at least a second assembly configured to apply the at least a second matrix component from the at least another source to fibers from at least one of the at least two fiber sources and to deliver fibers having the at least a second component applied thereto to a fiber storage element.

43. The system of claim 42, wherein the first matrix component comprises a substantially uncatalyzed resin component and the at least a second matrix component comprises a substantially unreacted hardener component.

44. The system of claim 43, wherein the first matrix component is formulated to comprise an amount of the resin component and, optionally, an amount of the hardener ranging from 0% of the hardener component to an adduct of the resin and the hardener components in less than stoichiometric proportions required to enable the matrix to harden and cure, and the at least a second matrix component is formulated to comprise an amount of the hardener component and, optionally, an amount of the resin component ranging from 0% of the resin component to an adduct of the hardener and the resin components in less than stoichiometric proportions required to enable the matrix to harden and cure.

45. The system of claim 42, wherein the fibers comprise glass fibers, carbon fibers, or organic fibers.

46. The apparatus of claim 43, wherein the first and the at least a second matrix components are comprised of polyesters, epoxies, anhydrides, amines, Lewis acid catalysts, imidazoles, cyanate esters, bismaleimides, or phenolic triazines and combinations thereof.

47. The system of claim 42, further comprising an ambient temperature fiber storage element environment.

48. A composite structure fabrication system comprising:
a source of a first matrix component;
at least another source of at least a second, different but cooperative matrix component;
wherein the first and the at least a second matrix components are formulated to form, when commingled, a stoichiometrically effective matrix enabled to cure and harden;
at least two fiber sources;
at least two fiber storage elements, each configured for storage of at least one tow of fibers;
a first assembly configured to apply the first matrix component from the source to fibers from at least one of the at least two fiber sources and to deliver fibers having the first matrix component applied thereto to a fiber storage element; and
at least a second assembly configured to apply the at least a second matrix component from the at least another source to fibers from at least one of the at least two fiber sources and to deliver fibers having the at least a second component applied thereto to another fiber storage element;
an assembly configured to commingle fibers having respectively applied thereto the first matrix component and the second matrix component into at least one consolidated tow; and
a forming assembly configured to receive at least one consolidated tow and apply the at least one consolidated tow to form a composite structure.

49. The system of claim 48, wherein the first matrix component comprises a substantially uncatalyzed resin component and the at least a second matrix component comprises a substantially unreacted hardener component.

50. The system of claim 49, wherein the first matrix component is formulated to comprise an amount of the resin component and, optionally, an amount of the hardener ranging from 0% of the hardener component to an adduct of the resin and the hardener components in less than stoichiometric proportions required to enable the matrix to harden and cure, and the at least a second matrix component is formulated to comprise an amount of the hardener component and, optionally, an amount of the resin component ranging from 0% of the resin component to an adduct of the hardener and the resin components in less than stoichiometric proportions required to enable the matrix to harden and cure.

51. The apparatus of claim 48, further comprising at least two fiber storage elements, each configured to store thereon at least one group of fibers having the first or the at least a second component applied thereto prior to delivery to the commingling assembly.

52. The system of claim 51, further comprising an ambient temperature fiber storage element environment.

53. The system of claim 48, wherein the fibers comprise glass fibers, carbon fibers, or organic fibers.

54. The system of claim 48, wherein the first and the at least a second matrix components are comprised of polyesters, epoxies, anhydrides, amines, Lewis acid catalysts, imidazoles, cyanate esters, bismaleimides, or phenolic triazines and combinations thereof.

55. A composite structure fabrication system, comprising:
a source of a first matrix component;
at least another source of at least a second, different but cooperative matrix component;
wherein the first and the at least a second matrix components are formulated to form, when commingled, a stoichiometrically effective matrix enabled to cure and harden;
at least one source of fibers;
a first assembly configured to receive fibers from the at least one source of fibers, to apply to the fibers a high-sizing matrix comprising one of the first and the at least a second matrix components to form at least one high-sized tow of fibers;
at least a second assembly configured to receive the at least first high-sized tow of fiber and to apply another of the first and the at least a second matrix components thereto; and
a commingling assembly configured to receive the at least one high-sized tow of fiber having the first and the at least a second matrix components applied thereto and to commingle the first and the at least a second matrix components; and
a fabrication assembly configured to receive the at least one high-sized tow of fiber having the first and the at least a second matrix components applied thereto and to apply the at least one high-sized tow of fiber having the first and the at least a second matrix components applied thereto to form a composite structure.

56. The system of claim 55, wherein the first matrix component comprises a substantially uncatalyzed resin component and the at least a second matrix component comprises a substantially unreacted hardener component.

57. The system of claim 56, wherein the first matrix component is formulated to comprise an amount of the resin component and, optionally, an amount of the hardener ranging from 0% of the hardener component to an adduct of the resin and the hardener components in less than stoichiometric proportions required to enable the matrix to harden and cure, and the at least a second matrix component is formulated to comprise an amount of the hardener component and, optionally, an amount of the resin component ranging from 0% of the resin component to an adduct of the hardener and the resin components in less than stoichiometric proportions required to enable the matrix to harden and cure.

58. The system of claim 55, further comprising an ambient temperature fiber storage element environment.

59. The system of claim 55, wherein the fibers comprise glass fibers, carbon fibers, or organic fibers.

60. The system of claim 55, wherein the first and the at least a second matrix components are comprised of polyesters, epoxies, anhydrides, amines, Lewis acid-catalysts, imidazoles, cyanate esters, bismaleimides, or phenolic triazines and combinations thereof.

61. The system of claim 55, further comprising at least one storage element configured to store the at least first high-sized tow of fibers having the one of the first and the at least a second matrix components applied thereto before application of the at least another of the first matrix and the at least a second matrix components.

62. The system of claim 61, further comprising an ambient temperature storage element environment.

63. The system of claim 55, wherein the one of the first and the at least a second matrix components has a concentration level ranging from about 1% up to about 40% by weight.

64. A fiber system precursor for use in fabrication of composite structures, comprising:
at least a first tow of fibers having a first matrix component applied thereto; and
at least a second tow of fibers having at least a second, different but cooperative matrix component applied thereto;
wherein the first and the at least a second matrix components are formulated to form, when commingled, a stoichiometrically effective matrix enabled to cure and harden.

65. The system of claim 64, wherein the first matrix component comprises a substantially uncatalyzed resin component and the at least a second matrix component comprises a substantially unreacted hardener component.

66. The system of claim 65, wherein the first matrix component is formulated to comprise an amount of the resin component and, optionally, an amount of the hardener ranging from 0% of the hardener component to an adduct of the resin and the hardener components in less than stoichiometric proportions required to enable the matrix to harden and cure, and the at least a second matrix component is formulated to comprise an amount of the hardener component and, optionally, an amount of the resin component ranging from 0% of the resin component to an adduct of the hardener and the resin components in less than stoichiometric proportions required to enable the matrix to harden and cure.

67. The system of claim 64, wherein the fibers comprise glass fibers, carbon fibers, or organic fibers.

68. The system of claim 64, wherein the first and the at least a second matrix components are comprised of polyesters, epoxies, anhydrides, amines, Lewis acid catalysts, imidazoles, cyanate esters, bismaleimides, or phenolic triazines and combinations thereof.
